(19) United States
(12) Patent Application Publication
(10) Pub. No.: US 2025/0053862 A1
(43) Pub. Date: Feb. 13, 2025

(54) MODEL TRAINING USING DIFFERENTIAL PRIVACY AND KNOWLEDGE TRANSFER

(71) Applicant: SAP SE, Walldorf (DE)

(72) Inventor: Caelin KAPLAN, Nice (FR)

(21) Appl. No.: 18/447,771

(22) Filed: Aug. 10, 2023

(51) Int. Cl. G06N 20/00

(52) U.S. Cl. CPC G06N 20/00

(57) ABSTRACT

Systems and methods include acquisition of training data comprising a plurality of target variable categories, training of a first classification model based on the training data, determination of node weights of the trained first classification model, and training of a second classification model using differential privacy and a first loss function including a weight loss term comparing the determined node weights of the trained first classification model to node weights of the second classification model.

### BACKGROUND

Developments in machine learning have recently accelerated due to increased availability of large datasets and affordable parallel processing power. Supervised learning is a type of machine learning in which a model is trained based on training data, where each instance of the training data includes values of several input variables and a value of a target variable. Supervised learning algorithms use the training data to iteratively train a model to map the input variables to the target variable. The trained model can then be used to infer a value of the target variable based on input data which includes values of the input variables.

Under certain circumstances, an attacker may reverse engineer the training data used to train a model by examining the model's output. This threat increases if the internal parameters of the model are accessible, such as when a trained model is implemented by a third-party service. Since training data may include personal or otherwise private data, particularly when the trained model is to be used for customer-related purposes, technical measures are sometimes needed to protect training data from such reverse engineering.

Differential privacy (DP) describes a class of training methods which produce a trained model exhibiting theoretical privacy guarantees with respect to the training data. However, the use of DP methods tends to produce a model which exhibits reduced performance (e.g., accuracy, precision, recall) as compared to a model trained using the same training data but without the use of DP methods. The reduction in performance may be so significant as to render DP-trained models unsuitable for their intended use.

Systems to improve the utility of DP-trained models while maintaining suitable privacy levels are desired.

### BRIEF DESCRIPTION OF THE DRAWINGS

FIG. 1 is a block diagram representing training of a classification model using differential privacy and based on a loss function including a predictive loss term and a weight loss term according to some embodiments.

FIG. 2 is a flow diagram of a process to train a classification model using differential privacy based on a loss function including a predictive loss term and a weight loss term according to some embodiments.

FIG. 3 is a block diagram representing training of a classification model based on a loss function including a predictive loss term according to some embodiments.

FIG. 4 illustrates extraction of node weights from a trained classification model according to some embodiments.

FIG. 5 is a flow diagram of one update iteration during training of a classification model using differential privacy and based on a loss function including a predictive loss term and a weight loss term according to some embodiments.

FIG. 6 illustrates determination of a lot of training data instances according to some embodiments.

FIG. 7A is a block diagram illustrating determination of a gradient of a loss function for each node weight of a classification model having first node weights with respect to a first training data instance according to some embodiments.

FIG. 7B is a block diagram illustrating determination of a gradient of a loss function for each node weight of a classification model having first node weights with respect to a second training data instance according to some embodiments.

FIG. 8 illustrates determination of a lot of training data instances according to some embodiments.

FIG. 9A is a block diagram illustrating determination of a gradient of a loss function for each node weight of a classification model having second node weights with respect to a third training data instance according to some embodiments.

FIG. 9B is a block diagram illustrating determination of a gradient of a loss function for each node weight of a classification model having second node weights with respect to a fourth training data instance according to some embodiments.

FIG. 10 illustrates a system to provide model training to applications according to some embodiments.

FIG. 11 is a block diagram of a hardware system for providing model training according to some embodiments.

### DETAILED DESCRIPTION

The following description is provided to enable any person in the art to make and use the described embodiments. Various modifications, however, will be readily-apparent to those in the art.

Some embodiments provide the benefits of DP (e.g., provable privacy guarantees) without the typical corresponding drop in model utility. In particular, a “protected” classification model is trained with DP and with a joint loss function including a weight loss term and a predictive loss term that minimizes the loss over the training data. The weight loss term may minimize the distance between the weights of the protected classification model and the weights of an “unprotected” classification model which was trained directly on training data without the use of DP. For a given DP budget, the addition of the weight loss term enables the classification model to achieve a higher model utility than traditional DP training.

The inclusion of the weight loss term may allow the protected classifier to train with DP using less steps than normally required, thereby enabling the use of a smaller privacy budget. By providing a more favorable utility-privacy tradeoff than existing systems, embodiments may allow the use of DP-trained models in scenarios where they was previously unsuitable.

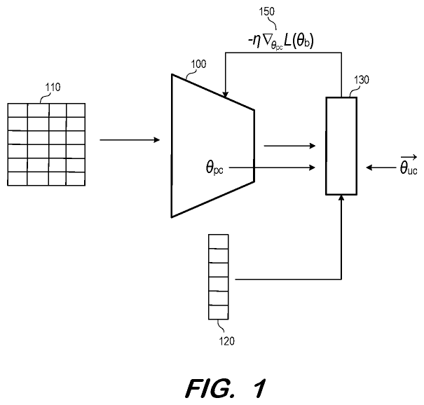

FIG. 1 is a block diagram representing training of a classification model using differential privacy and based on a loss function including a predictive loss term and a weight loss term according to some embodiments. The illustrated components may be implemented using any suitable combination of computing hardware and/or software that is or becomes known. In some embodiments, two or more components are implemented by a single computing device. Two or more components of FIG. 1 may be co-located. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Training data includes input variable data 110 and corresponding target variable data 120. Each corresponding row of input variable data 110 and target variable data 120 will be referred to as a training data instance. Accordingly, each training data instance includes values of corresponding input variables (i.e., columns, features, etc.) and a value of a target variable. The values of each variable may conform to any suitable format. According to some embodiments, the target variable is a categorical variable and the value of the target variable within each training data instance is a class.

The training data instances may comprise records of a database table in some embodiments. The records may comprise a query result based on one or more database tables of a database, for example. In some embodiments, the training data instances comprise a random sampling of records from a much larger set of records. As mentioned above, the training data instances may include values which are considered private, secret, or otherwise disclosure-protected.

The training data is used to train classification model 100. Model 100 may comprise any type of iterative learning-compatible network, algorithm, decision tree, etc., that is or becomes known. Model 100 may be designed to perform binary classification or multi-class classification (i.e., inference of a class from a set of more than two classes).

Classification model 100 may comprise a network of nodes which receive input, change internal state according to that input, and produce output depending on the input and internal state. The output of certain nodes is connected to the input of other nodes to form a directed and weighted graph. The weights are iteratively modified during training using supervised learning algorithms, examples of which will be described below.

During training of model 100, several instances of input variable data 110 are input to model 100. Loss layer component 130 acquires resulting values output by model 100 and computes gradient 150 of a loss function L with respect to current node weights θ_{pc} of model 100. Loss function L includes a predictive loss term as is known in the art (e.g., a cross-entropy loss term) and a weight loss term which is based on current node weights θ_{pc} and on node weights θᵤₑ of a previously-trained classification model. As will be described below, the previously-trained model may have been trained without DP, based on the same training data instances as shown in FIG. 1, and/or using a loss function including the same predictive loss term.

The weight loss term compares current node weights θ_{pc} and node weights θ_{uc}. In some embodiments, the weight loss term computes the L1 or L2 distance between current node weights θ_{pc} and node weights θ_{uc}. Node weights θ_{uc}. may be represented by a vector or a matrix to facilitate this computation. Use of the weight loss term may therefore result in training model 100 to minimize a difference between node weights θ_{pc} and node weights θ_{uc}. Since node weights θ_{uc} represent a model which was previously trained to maximize predictive accuracy, use of the weight loss term may result in a greater predictive performance of DP-trained model 100 than would be achieved but for the weight loss term.

Regarding DP, loss layer component 130 determines privacy-enhanced composite gradient 150 based on the computed gradients. For example, loss layer component 130 may clip the magnitude of all determined gradients which exceed a threshold magnitude. After clipping, the resulting gradients are averaged and noise is added to the average gradient to determine composite gradient 150. As is known in the art, current node weights θ_{pc} are then updated by subtracting a factor of composite gradient 150 therefrom (i.e., by subtracting from each node weight a factor of a partial differential of the loss function with respect to the node weight). The particular factor is specified by learning rate n.

The process then repeats for another subset of training data, iteratively modifying node weights θ_{pc} of model 100 until the corresponding loss, performance, and or other metric of model 100 is satisfactory. Trained model 100 may then be used to infer a value of the target variable (i.e., a classification) based on a set of values of the input variables. Trained model 100 may be embodied by a set of linear equations, executable program code, a set of hyperparameters defining its structure and a set of corresponding weights, or any other representation of the mapping of the input variables to the target variable which was learned as a result of the training. In some embodiments, trained model 100 is implemented by a cloud service and instances are input thereto and classifications are received therefrom via a Web API.

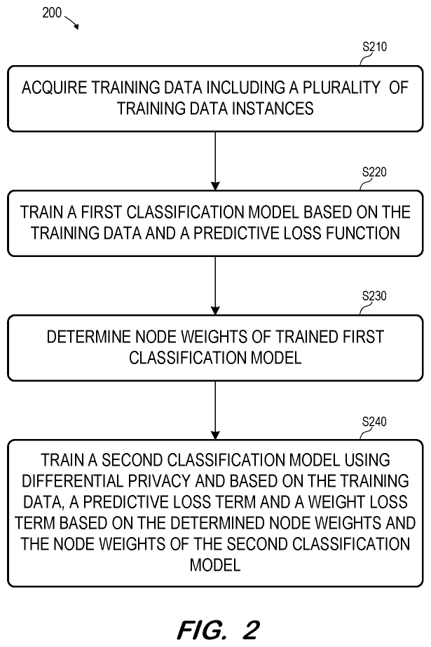

FIG. 2 comprises a flow diagram of process 200 to train a classification model using differential privacy based on a loss function including a predictive loss term and a weight loss term according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

Process 200 may be initiated by a request to generate a classification model to predict a class based on a set of input variable values. The request may include or reference training data based on which the classification model is to be generated. Accordingly, training data including a plurality of training data instances is acquired at S210. As described above, each instance includes a value for each of a plurality of input variables and a target variable, where each value of the target variable is a class.

A first classification model is trained at S220 based on the training data. The first classification model may comprise any type of iterative learning-compatible machine learning network that is or becomes known. If the target variable includes only one class, the first classification model may comprise a binary classification model designed to output a probability of whether a set of values of the input variables represents the one class. If the target variable includes more than one class, the first classification model may comprise a multi-class classification model designed to output a probability corresponding to each of the more than one classes.

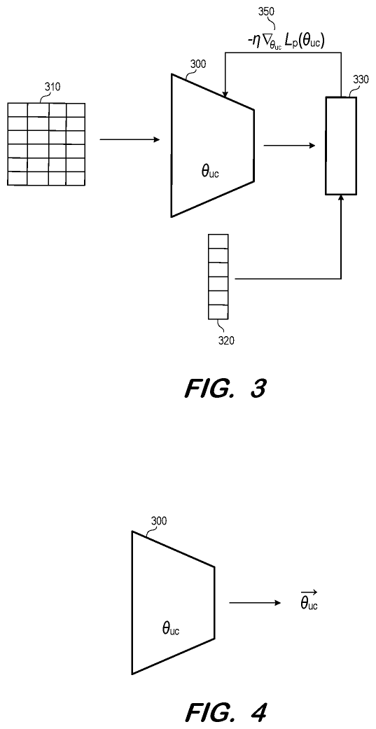

FIG. 3 illustrates training of first classification model 300 according to some embodiments. The node weights θᵤₑ of first classification model are initially set to default values as is known in the art. The training data acquired at S210 is represented by input variable data 310 and target variable data 320.

During one training iteration, several instances of input variable data 310 are input to model 300. Loss layer component 330 acquires resulting values output by model 300 and computes gradient 350 of a loss function with respect to current node weights θ_{uc} of model 300. The loss function includes a predictive loss term so as to minimize the predictive accuracy of model 300. In some embodiments, the loss function includes only the cross-entropy loss term:

$$- \frac{1}{n} {\sum }_{i = 1}^{n} {y}_{i} \cdot log ( {f ( {x}_{i} )}_{y} )$$

where n is the total number of training data instances per iteration, yᵢ is the target variable value (i.e., the ground truth) of the iₜₕ training data instance, and f(xᵢ)_{y} is the predicted probability for value yᵢ.

Node weights θ_{uc} are updated based on the computed gradient 350. In particular, for each node weight, a partial differential of the loss function with respect to the node weight is multiplied by a learning rate and subtracted from the node weight. The process repeats with respect to another several instances of input variable data 310 until the performance of model 300 is deemed satisfactory, at which point model 300 and then-current node weights θ_{uc} are deemed trained. Model 300 may be trained using any type of minimization strategy according to some embodiments.

The node weights of the trained first classification model are determined at S230. FIG. 4 depicts extraction of trained node weights θ_{uc} from trained model 300 in vector format. Any suitable system for extracting node weights from a trained model may be employed at S230.

Next, at S240, a second classification model is trained using differential privacy and based on the acquired training data. The training uses a loss function including a predictive loss term and a weight loss term based on the node weights determined at S230 and the node weights of the second classification model.

The structure of the second classification model is identical to the structure of the first classification model in some embodiments. Accordingly, the hyperparameter values defining the layers, nodes within the layers, and layer-to-layer connections of the second classification model may be identical to the hyperparameter values defining the layers, nodes within the layers, and layer-to-layer connections of the first classification model.

FIG. 1 and its accompanying description comprise an example of S240 according to some embodiments. As illustrated and described, one or more instances of input variable data 110 are input to model 100 and loss layer component 130 computes gradient 150 of a loss function L with respect to current node weights θpc based on a predictive loss term and a weight loss term. The predictive loss term of loss function Lis based on the values output by model 100 and may comprise the cross-entropy loss term set forth above.

The weight loss term is based on current node weights θ_{pc} and on node weights θ_{uc} of the trained first classification model. For example, the weight loss term may comprise a representation of a distance between a vector or matrix including current node weights θ_{pc} and a vector or matrix including node weights θ_{uc}. Any metric may be used to quantify the distance between θ_{pc} and θ_{uc}. In some embodiments, the weight loss term specifies the L1 distance (e.g., ∥θpc−θuc∥₁) or the L2 distance (e.g., ∥θpc−θuc∥₂).

Continuing with S240, loss layer component 130 determines privacy-enhanced composite gradient 150 from the computed gradients. After clipping the magnitude of all determined gradients which exceed a threshold magnitude, the resulting gradients are averaged and noise is added to the average gradient to determine composite gradient 150. Current node weights θ_{pc} are then updated by subtracting from each node weight a partial differential of the loss function with respect to the node weight, as factored by learning rate n. This process then repeats for the second classification model with respect to another subset of training data. The node weights of the second classification model are thereby iteratively modified until the corresponding loss, performance, and or other metric of the second classification model is satisfactory.

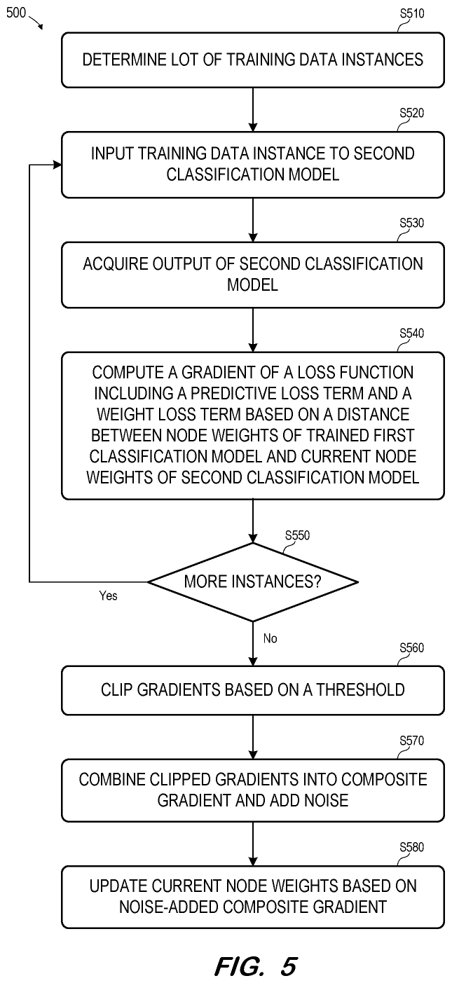

FIG. 5 is a flow diagram of process 500 according to some embodiments. Process 500 consists of one update iteration during training of a classification model using differential privacy and based on a loss function including a predictive loss term and a weight loss term. Process 500 will be described as one update iteration during the training of a second classification model at S240.

A set of training data instances, referred to as a “lot”, is determined at S510. A lot will be considered as a group of training data instances which are used during one training iteration that resulting in one update to the node weights of the model.

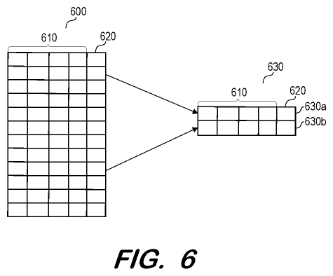

FIG. 6 illustrates the determination of a lot of training data instances according to some embodiments. Training data instances 600 consist of many rows, with each row including values of input variables 610 and a target variable 620. As illustrated, S510 may consist of selection of random rows 630 of training data instances 600, identified as rows 630a and 630b. The number of training data instances in a lot may be much larger than two.

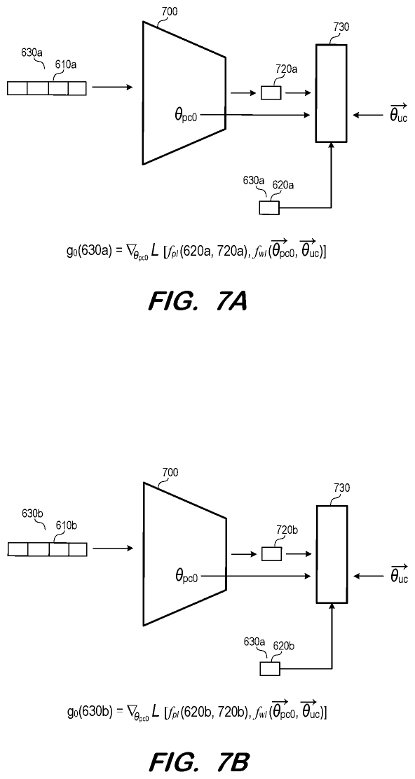

A first training data instance of the lot is input to the second classification model at S520 and the resulting output is acquired therefrom at S530. FIG. 7A illustrates input of the values 610a of the input variables of row 630a to classification model 700 at S520. Model 700 then operates in accordance with current node weights θ_{pc0} to generate output 720a, which is acquired by loss layer component 730 at S530.

Next, at S540, loss layer component 730 computes a gradient of a loss function with respect to current node weights θ_{pc0}. As shown in FIG. 7A, the loss function L includes a predictive loss term which is based on output 720a and actual classification 620a and a weight loss term which is based on node weights θ_{pc0} of the current training iteration and on node weights θ_{uc} of a previously-trained classification model. The predictive loss term may be a cross-entropy loss term and the weight loss term may comprise a distance measure. The gradient is denoted g₀ (630a) because it is associated with the first (i.e., 0^{th}) training iteration and row 630a.

It is determined at S550 whether the lot of training data instances includes additional instances. In the present example, the lot also includes row 630b, so flow returns to S520. FIG. 7B illustrates input of the values 610b of the input variables of row 630b to classification model 700 at S520. Model 700 then operates in accordance with current node weights θ_{pc0} to generate output 720b, which is acquired by loss layer component 730 at S530.

Loss layer component 730 again computes a gradient of a loss function with respect to current node weights θ_{pc} at S540. However, as shown in FIG. 7B, the predictive loss term of the loss function L is now based on output 720b and corresponding actual classification 620b. The weight loss term remains based on node weights θ_{pc0} and node weights θ_{uc}. The gradient corresponding to FIG. 7B is denoted g₀(630b) because it is associated with the first (i.e., 0^{th}) training iteration and with row 630b.

Flow proceeds from S550 to S560 since no training data instances remain in the lot of the current training iteration. The determined gradients g₀(630a) and g₀(630b) are clipped at S550 based on a specified threshold. For example, if the magnitude of a gradient exceeds the threshold, the gradient is scaled down at S560 such that the magnitude of the gradient no longer exceeds the threshold. If the magnitude of a gradient does not exceed the threshold, the gradient is unchanged. According to some embodiments, S560 is implemented using the following algorithm for each g₀ determined at S540 during the current iteration:

$${g}_{c 0} \to {g}_{0} / max ( 1 , \frac{{‖ {g}_{0} ‖}_{2}}{C} )$$

Next, at S570, the clipped gradients (which include both the gradients that were scaled at S560 and the gradients which were unchanged) are combined into a composite gradient. In some embodiments, the composite gradient is an average of the clipped gradients. S570 also includes the addition of noise to the composite gradient. The noise may be Gaussian and controlled by a scaling factor as is known in the art. Current node weights θ_{pc0} are updated at S580 based on the noise-added composite gradient. For example, S580 may include from each node weight by 1/n of the loss function with respect to that node weight.

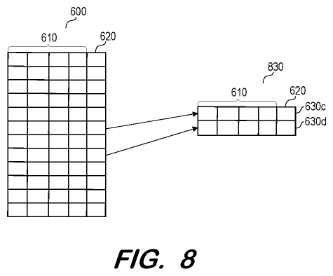

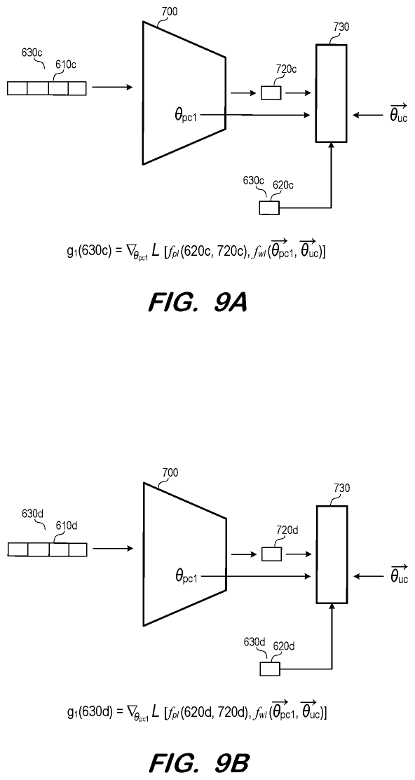

FIGS. 8, 9A and 9B illustrate a next iteration of process 500 according to some embodiments. FIG. 8 illustrates the determination of second lot 830 consisting of rows 630c and 630d from training data instances 600. FIG. 9A illustrates input of values 610c of the input variables of row 630c to classification model 700, which operates during this iteration in accordance with updated node weights θ_{pc1} to generate output 720c. Loss layer component 730 computes gradient g₁(630c) of a loss function with respect to current node weights θ_{pc1} based on output 720c, actual classification 620c, node weights θ_{pc1} and node weights θ_{uc}.

Similarly, FIG. 9B illustrates input of values 610d of row 630d to classification mode 700 to generate output 720d. Loss layer component 730 then computes gradient g₁(630d) of the loss function with respect to current node weights θ_{pc1} based on output 720d, actual classification 620d, node weights θ_{pc1} and node weights θ_{uc}. Gradients g₁(630c) and g₁(630d) are then clipped at S560 and combined into a composite gradient to which noise is added at S570. Next, at S580, now-current node weights θ_{pc1} are updated based on this noise-added composite gradient.

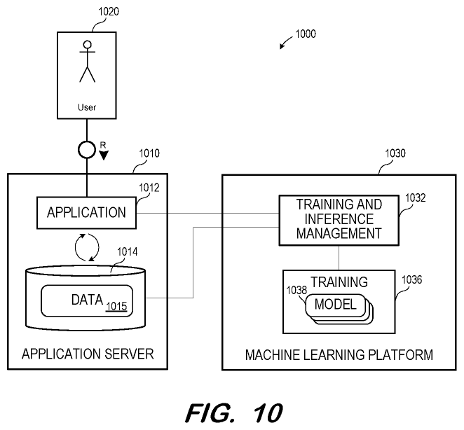

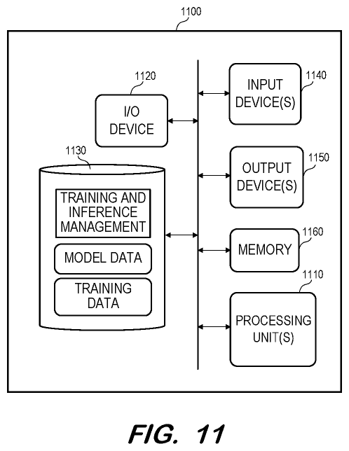

FIG. 10 illustrates system 1000 to provide model training to applications according to some embodiments. Application server 1010 may comprise an on-premise or cloud-based server providing an execution platform and services to applications such as application 1012. Application 1012 may comprise program code executable by a processing unit to provide functions to users such as user 1020 based on logic and on data 1015 stored in data store 1014. Data 1015 may be column-based, row-based, object data or any other type of data that is or becomes known. Data store 1014 may comprise any suitable storage system such as a database system, which may be partially or fully remote from application server 1010, and may be distributed as is known in the art.

According to some embodiments, user 1020 may interact with application 1012 (e.g., via a Web browser executing a client application associated with application 1012) to request a trained classification model based on specified database records. The request may also specify a target variable of the model. In response, application 1012 may call training and inference management component 1032 of machine learning platform 1030 to request training of a corresponding model according to some embodiments.

Based on the request, training and inference management component 1032 may receive the specified training data from data 1015 and instruct training component 1036 to train a differentially-private classification model 1038 based on the training data as described herein. Application 1012 may then use the trained model to generate inferences based on input data selected by user 1020.

In some embodiments, application 1012 and training and inference management component 1032 may comprise a single system, and/or application server 1010 and machine learning platform 1030 may comprise a single system. In some embodiments, machine learning platform 1030 supports model training and inference for applications other than application 1012 and/or application servers other than application server 1010.

FIG. 11 is a block diagram of a hardware system providing model training according to some embodiments. Hardware system 1100 may comprise a general-purpose computing apparatus and may execute program code to perform any of the functions described herein. Hardware system 1100 may be implemented by a distributed cloud-based server and may comprise an implementation of machine learning platform 1030 in some embodiments. Hardware system 1100 may include other unshown elements according to some embodiments.

Hardware system 1100 includes processing unit(s) 1110 operatively coupled to I/O device 1120, data storage device 1130, one or more input devices 1140, one or more output devices 1150 and memory 1160. I/O device 1120 may facilitate communication with external devices, such as an external network, the cloud, or a data storage device. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into hardware system 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, and RAM devices, while memory 1160 may comprise a RAM device.

Data storage device 1130 stores program code executed by processing unit(s) 1110 to cause system 1100 to implement any of the components and execute any one or more of the processes described herein. Embodiments are not limited to execution of these processes by a single computing device. Data storage device 1130 may also store data and other program code for providing additional functionality and/or which are necessary for operation of hardware system 1100, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
acquire training data comprising a plurality of target variable categories;
train a first classification model based on the training data;
determine node weights of the trained first classification model; and
train a second classification model using differential privacy and a first loss function including a weight loss term comparing the determined node weights of the trained first classification model to node weights of the second classification model.

2. A system according to claim 1, wherein the first classification model is trained based on a second loss function including a predictive loss term,
the first loss function comprises the predictive loss term, and
the weight loss term determines a distance between the determined node weights of the trained first classification model and the node weights of the second classification model.

3. A system according to claim 2, wherein the second classification model is trained based on the training data.

4. A system according to claim 2, wherein training of the second classification model comprises:
for each of a first plurality of a plurality of instances of the training data, determine a gradient of the first loss function with respect to the node weights of the second classification model;
determine a composite gradient of the first loss function with respect to the node weights of the second classification model based on the gradient of the first loss function determined for each of the first plurality of the plurality of instances; and
update the node weights of the second classification model based on the composite gradient.

5. A system according to claim 4, wherein determination of the gradient of the first loss function for each of the first plurality of instances comprises limiting of a magnitude of each gradient based on a threshold, and
wherein determination of the composite gradient comprises determination of an average gradient of the gradients and addition of noise to the average gradient.

6. A system according to claim 1, wherein training of the second classification model comprises:
for each of a first plurality of a plurality of instances of the training data, determine a gradient of the first loss function with respect to the node weights of the second classification model;
determine a composite gradient of the first loss function with respect to the node weights of the second classification model based on the gradient of the first loss function determined for each of the first plurality of the plurality of instances; and
update the node weights of the second classification model based on the composite gradient.

7. A system according to claim 6, wherein determination of the gradient of the first loss function for each of the first plurality of instances comprises limiting of a magnitude of each gradient based on a threshold, and
wherein determination of the composite gradient comprises determination of an average gradient of the gradients and addition of noise to the average gradient.

8. A method comprising:
acquiring training data comprising a plurality of instances, each instance comprising a value of each of a plurality of input variables and of a target variable, where the values of the target variable comprise a plurality of categories;
training a first classification model based on the training data;
determining node weights of the trained first classification model; and
training a second classification model using a first loss function including a weight loss term comparing the determined node weights of the trained first classification model to node weights of the second classification model, and by:
for each of a first plurality of the plurality of instances, determining a gradient of the first loss function with respect to the node weights of the second classification model;
determining a composite gradient of the first loss function with respect to the node weights of the second classification model based on the gradient of the first loss function determined for each of the first plurality of the plurality of instances; and
updating the node weights of the second classification model based on the composite gradient.

9. A method according to claim 8, wherein the first classification model is trained based on a second loss function including a predictive loss term,
the first loss function comprises the predictive loss term, and
the weight loss term determines a distance between the determined node weights of the trained first classification model and the node weights of the second classification model.

10. A method according to claim 9, wherein the second classification model is trained based on the training data.

11. A method according to claim 9, wherein determining the gradient of the first loss function for each of the first plurality of instances comprises limiting a magnitude of each gradient based on a threshold, and
wherein determining the composite gradient comprises determining an average gradient of the gradients and addition of noise to the average gradient.

12. A method according to claim 8, wherein determining the gradient of the first loss function for each of the first plurality of instances comprises limiting a magnitude of each gradient based on a threshold, and
wherein determining the composite gradient comprises determining an average gradient of the gradients and addition of noise to the average gradient.

13. A non-transitory medium storing executable program code executable by at least one processing unit of a computing system to cause the computing system to:
acquire training data comprising a plurality of target variable categories;
train a first classification model based on the training data;
determine node weights of the trained first classification model; and
train a second classification model using differential privacy and a first loss function including a weight loss term determining a distance between the determined node weights of the trained first classification model and node weights of the second classification model.

14. A medium according to claim 13, wherein the first classification model is trained based on a second loss function including a predictive loss term, and the first loss function comprises the predictive loss term.

15. A medium according to claim 14, wherein the second classification model is trained based on the training data.

16. A medium according to claim 14, wherein training of the second classification model comprises:
for each of a first plurality of a plurality of instances of the training data, determine a gradient of the first loss function with respect to the node weights of the second classification model;
determine a composite gradient of the first loss function with respect to the node weights of the second classification model based on the gradient of the first loss function determined for each of the first plurality of the plurality of instances; and
update the node weights of the second classification model based on the composite gradient.

17. A medium according to claim 16, wherein determination of the gradient of the first loss function for each of the first plurality of instances comprises limiting of a magnitude of each gradient based on a threshold, and
wherein determination of the composite gradient comprises determination of an average gradient of the gradients and addition of noise to the average gradient.

18. A medium according to claim 13, wherein training of the second classification model comprises:
for each of a first plurality of a plurality of instances of the training data, determine a gradient of the first loss function with respect to the node weights of the second classification model;
determine a composite gradient of the first loss function with respect to the node weights of the second classification model based on the gradient of the first loss function determined for each of the first plurality of the plurality of instances; and
update the node weights of the second classification model based on the composite gradient.

19. A medium according to claim 18, wherein determination of the gradient of the first loss function for each of the first plurality of instances comprises limiting of a magnitude of each gradient based on a threshold, and
wherein determination of the composite gradient comprises determination of an average gradient of the gradients and addition of noise to the average gradient.
